(19) United States
(12) Patent Application Publication
(10) Pub. No.: US 2018/0099610 A1
(43) Pub. Date: Apr. 12, 2018

(54) ILLUMINATED HANDLE ASSEMBLY

(71) Applicant: Scott Meyers, Holland, MI (US)

(72) Inventor: Scott Meyers, Holland, MI (US)

(21) Appl. No.: 15/289,602

(22) Filed: Oct. 10, 2016

(51) Int. Cl. B60N 3/02; F21V 3/00; F21V 19/00; F21V 23/00; E05B 85/10; E05B 1/00; H05B 37/02; E05B 1/04

(52) U.S. Cl. CPC B60Q 3/267; F21S 45/50; B60N 3/02; F21V 3/00; F21V 19/003; F21Y 2115/10; E05B 85/10; E05B 1/0015; H05B 37/0281; E05B 1/04; H05B 37/0227; F21V 23/003

(57) ABSTRACT

An illuminated grab handle assembly is configured to connect to and illuminate a mounting surface. The assembly includes a housing having a body and a top cover. The body has a generally hollow shape and an open top portion that is covered and sealed by the top cover. A translucent window is positioned in the surface of the body and configured to allow light to pass from within the body to the mounting surface. A lighting element is positioned within the interior of the body and positioned to direct light out of the window and to the mounting surface.

### FIELD OF INVENTION

The present invention relates to a handle device for providing directed illumination to a target mounting surface.

### BACKGROUND

Grab handles or support railings are commonly used on vehicles which require a person to step up into the cab or coach, such as in recreational vehicles (RVs), tractors for semi-trailer trucks, emergency vehicles, and utility vehicles. Additionally, such handles are commonly used on water vehicles, such as boats, to provide a railing support for walking up or down stairs or mounted to the exterior surface of the boat to assist in controlling the vehicle during docking procedures. Typically, grab handles are mounted to the side of the vehicle adjacent the door to assist a person climbing into the vehicle, or along a wall near a stairwell to assist a person using the stairs.

Illuminated grab handles are known to provide several benefits over traditional grab handles. First, illuminated handles are more aesthetically pleasing because they illuminate an area surrounding the handle. Further, illuminated handles provide an additional source of light and alert users as to the location of the grab bar in otherwise dim lighting.

Traditionally, illuminated grab handles include a light source disposed within a clear plastic or acrylic portion, such as a clear plastic tube. The light is dispersed through the clear portion to illuminate at least a portion of the handle.

One drawback to these types of grab handles is that the light is not focused in a specific direction, but instead is dispersed in all directions about the clear housing. This is less aesthetically pleasing than a focused and more purposeful light pattern.

A second drawback is that the clear plastic or acrylic section of traditional illuminated handles weakens the overall structure of the handle. Because of the nature of their use, grab handles are commonly designed to withstand high impact and stress. Accordingly, grab handles are often constructed of heavy duty materials. Traditional illuminated grab handles that utilize a clear plastic portion as part of the handle weaken the overall strength and durability of the handle over handles comprised entirely of heavy duty materials.

Additionally, some grab handle designs incorporate a curved shape to enhance the aesthetic appeal and increase overall strength of the handle. Traditional illuminated grab handles, however, utilize a rigid light source that does not accommodate the curvature of an arced or curved handle design. Accordingly, many illuminated grab handle designs are forced to be generally linear instead of curved.

Accordingly, an improved illuminated grab handle assembly design is needed in the industry.

### SUMMARY

An illuminated grab handle assembly is generally presented. The illuminated grab handle assembly is configured to connect to and illuminate a mounting surface. The illuminated grab handle assembly includes a housing having a body and a top cover. The body comprises a first mounting base, a second base, and a crossbar extending between the first mounting base and the second mounting base. The body has a generally hollow shape and an open top portion. The top cover is connected to and configured to cover the open top portion.

The housing includes a cavity formed in the body and extending for a length between the first mounting base and the second mounting base and window positioned in a surface of the body and corresponding to at least a portion of the cavity. The window comprising a translucent surface configured to allow light to pass from within the body to the mounting surface. A lighting element is positioned within the body and positioned to direct light out of the window and to the mounting surface.

### BRIEF DESCRIPTION OF THE DRAWINGS

The operation of the invention may be better understood by reference to the detailed description taken in connection with the following illustrations, wherein:

FIG. 1 illustrates a perspective view of an illuminated grab handle;

FIG. 2 illustrates a perspective view of the underside of an illuminated grab handle;

FIG. 3 illustrates a side view of an illuminated grab handle; and

FIG. 4 illustrates an assembly view of an illuminated grab handle.

FIG. 5 illustrates a lengthwise cross-sectional view of the illuminated grab handle.

FIG. 6 illustrates a cutaway view of the illuminated grab handle.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

An illuminated grab handle 10 is generally presented. The grab handle 10 is intended to be mounted to a wall surface to provide a support rail for users near the mounting location. The grab handle 10 may optionally be mounted on a recreational vehicle (“RV”) or boat, such as near a door or stairway on the boat or RV or on an outer surface of the boat. The illuminated grab handle may be configured to direct light back to the surface on which it is mounted.

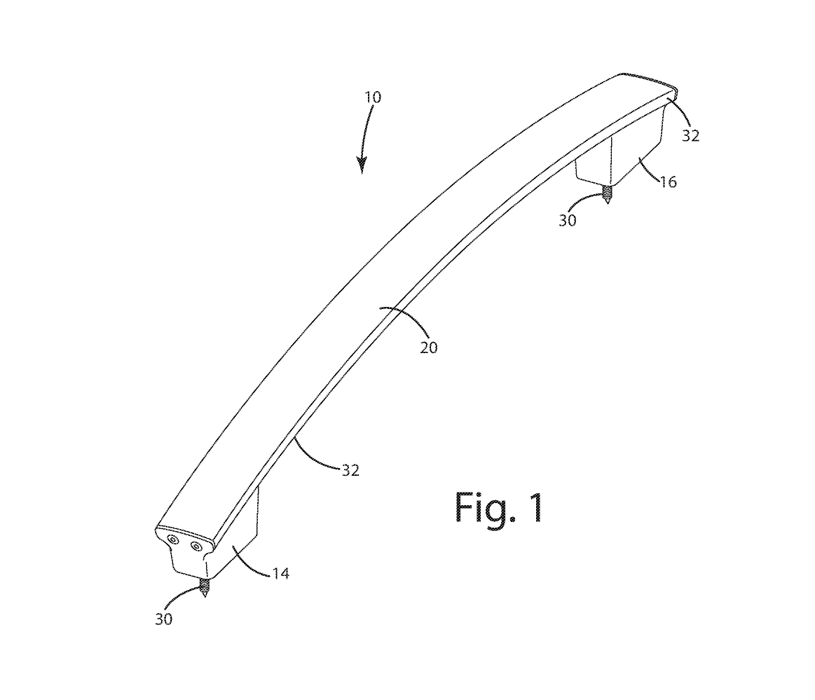

The illuminated grab handle 10 may comprise an outer housing 12. As shown in FIGS. 1-4, the outer housing 12 may be generally curved or arc shaped, extending from a first mounting base 14 to a second mounting base 16. The first and second mounting bases 14, 16 may be configured to mount or connect to a mounting surface, as further described below.

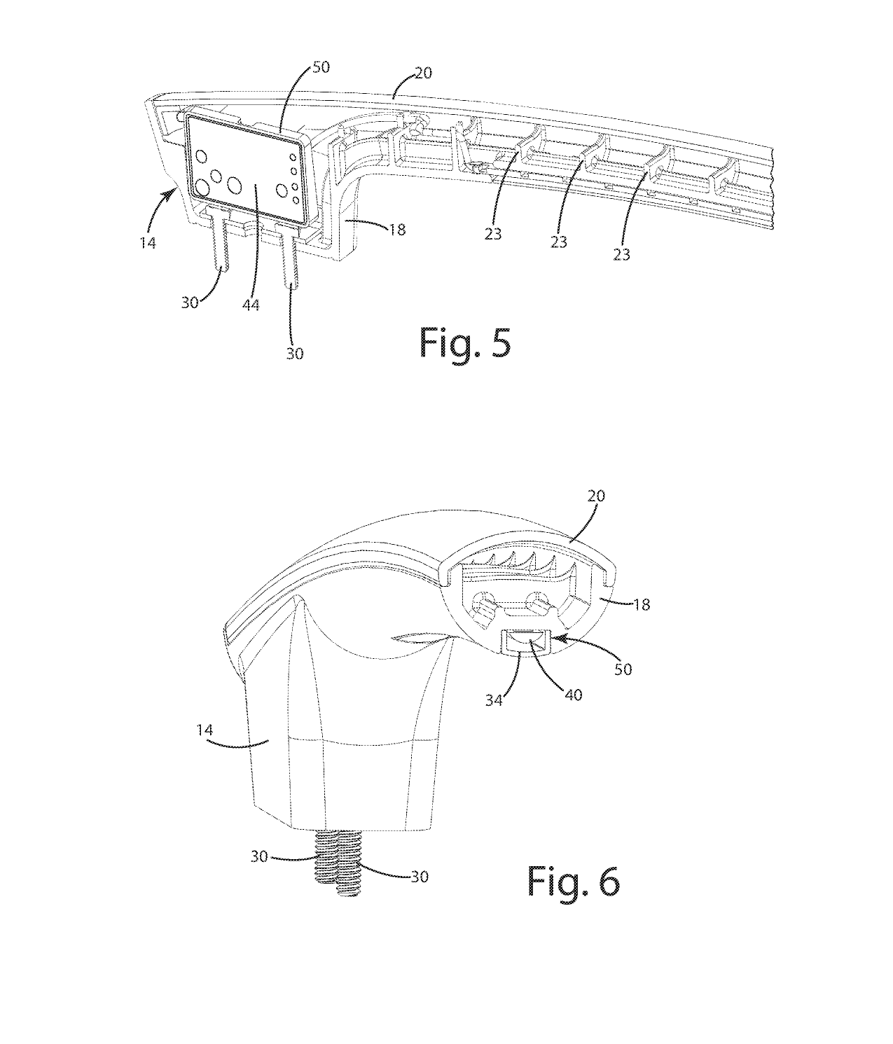

The housing 12 may generally comprise two pieces, namely the body 18 and the top cover 20. The body 18 may comprise at least a portion of the first mounting base 14 and the second mounting base 16 and a crossbar 22. The crossbar 22 may extend between the first and second mounting bases 14, 16 and include a slight curved or arched shape, arching away from the mounting surface, as shown in FIG. 3. The body 18 may be formed of any appropriate material, such as plastic, polymer, aluminum, or any appropriate metal or other material. The body 18 may be generally hollow having an open top and may further include internal support structures 23 disposed within the otherwise hollow interior. The support structures 23 may comprise ribs arranged within the body 18 to provide structural support for the handle. The first and second mounting bases 14, 16 may include a first and second flat surface 24, 26 respectively. The flat surfaces 24, 26 may be configured to engage a wall or mounting surface. The flat surfaces 24, 26 may include one or more openings 28 therein to receive mounting screws 30 therethrough. The mounting screws 30 may be used to fasten the grab handle assembly 10 to the desired mounting surface. The mounting screws 30 may be inserted from within the body 18 through openings 28, as shown in FIG. 5.

The top cover 20 may be positioned over the opening in the body 18. The cover 20 may be any appropriate shape, such as generally rectangular having longer sides extending along the length of the handle, as shown in FIG. 3. The top cover 20 may be made of any appropriate material, such as a metal, alloy, plastic, polymer, or the like. In an embodiment, the top cover 20 may be formed of a material, such as aluminum or brushed aluminum, different than the material of the body 18. Further, in another embodiment, the body 18 may be formed of a translucent or semi-translucent material to allow a portion of light within the body 18 to pass through the body. The top cover 20 may be formed of a translucent or non-translucent material and combined with the translucent body 18.

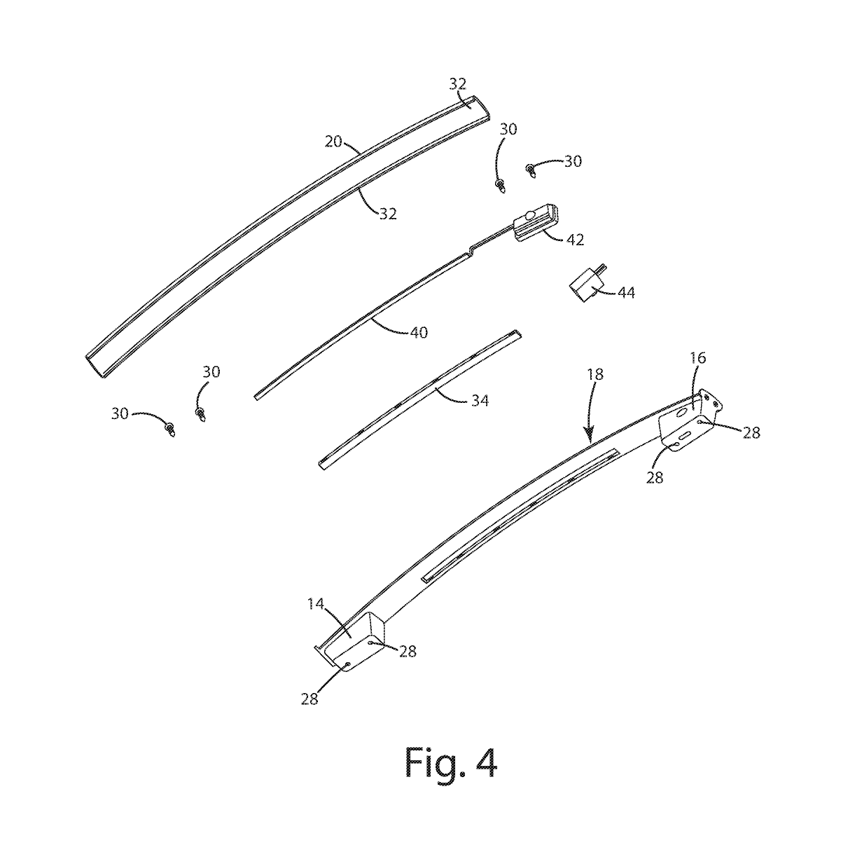

The top cover 20 may be connected to the body 18 to cover the top opening in the body. In an embodiment, the cover may include a flange 32 extending from the long sides of the top cover 20 toward the body 18. The flange 32 may be curled or bent to engage the body 18. The top cover 20 may be slidable or snapable onto the body 18 over the lip and held in place by a compression fit. The top cover 20 may be bolted to the body 18 by any appropriate screws located at respected ends of the body 18, as shown in FIG. 4.

The body 18 may include a translucent portion or window 34 to allow light to pass from the interior of the grab handle 10 to the exterior. The window 34 may be made of any appropriate translucent material, such as clear plastic or acrylic. In an embodiment, the window 34 may comprise the only translucent portion of the grab handle 10, with the remaining materials being opaque. The window 34 may be located in a surface of the crossbar 22 and arranged to the direct light from the illuminated grab handle 10 toward the mounting surface.

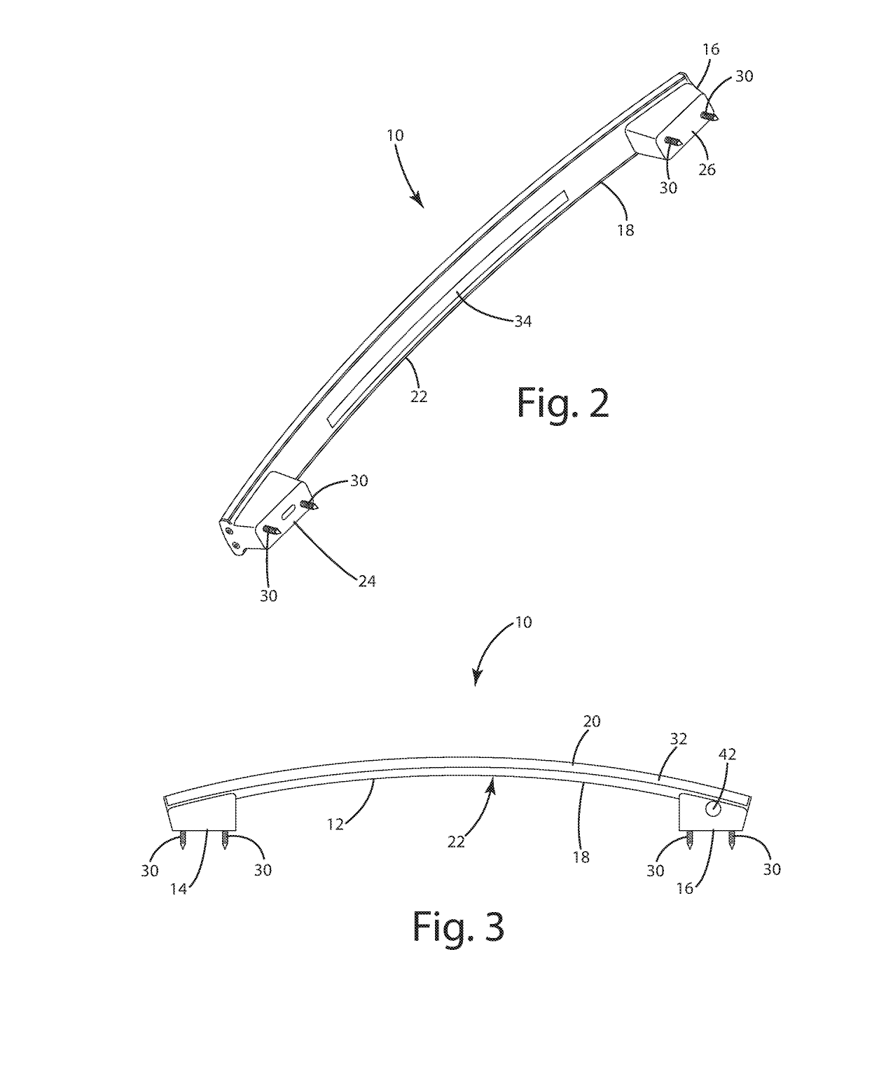

The window 34 may be any appropriate shape to create a desired light pattern. For example, as shown in FIGS. 2 and 4, the window 34 may be generally rectangular to produce a rectangular light pattern on the mounting surface. Alternatively, the window 34 may be uniquely shaped to create a unique light pattern on the mounting surface.

The window 34 may be formed flush with the body 18 so as not to interfere with a user gripping the grab handle 10. For example, the window 34 may sit within an opening in the body 18 and be mounted flush within the opening with the outer surface of the body 18. The window 34 may be mechanically seated in the opening or may be fixed in place with an epoxy or other appropriate adhesive.

The illuminated grab handle 10 may include a lighting element 40 positioned within the interior of the body 18. The lighting element 40 may be configured to project light through the window 34 toward the mounting surface.

In an embodiment, the lighting element 40 may be a liner light component, such as an LED linear light component 40. The linear light component 40 may extend along a length, such as the length of the window 34 or longer. The lighting element 40 may be oriented to face the window 34 to project light toward the mounting surface. The lighting element 40 may be seated in the body 18 facing the window 34 with a support structure positioned to hold the lighting element 40 in place. As shown in FIG. 6, a cavity 50 may be formed in the underside of the body 18 along the underside of the crossbar 22. The cavity 50 may extend lengthwise along the crossbar 22, such as generally corresponding to the position and length of the window 34, and may be sized and shaped to receive the lighting element therein. The cavity 50 may be arranged to isolate the lighting element 40 from the remainder of the internal portion of the body 18. The cavity 50 may hold the lighting element in place and facing away from the body 18 and toward the window 34.

The liner light component 40 may provide consistent light along its entire length and may be design to diffuse the light before it exits the body 18 to provide a consistent light pattern on the mounting surface. An example of a linear light component 40 that may be used is disclosed in U.S. patent application Ser. No. 14/467,384 entitled Diffused Flexible LED Linear Light Assembly (“the '384 Application”). The '384 Application is hereby incorporated by reference in its entirety.

The lighting element 40 may be flexible in order to mold to the curves and contours of the grab handle assembly 10. As shown in FIG. 3, the grab handle assembly 10 may have a generally arced shape, arcing away from the mounting surface. The lighting element 40 may be flexible enough to mold to the body 18 along the curve of the body to maintain a constant proximity between the flexible lighting element 40 and the window 34. For example, the lighting element may include a flexible printed circuit board, as set forth in the '384 Application, to allow the lighting element to mold to the contours of the grab handle assembly 10. Alternatively, the body 18 may be designed to maintain a flat surface near the window 34 to allow the lighting element 40 to remain flat.

The lighting element 40 may be designed to be hermetically sealed to prevent any water damage to the electronics and/or circuitry in the lighting. Specifically, the lighting element 40 may be surrounded by a silicone jacket and sealed in silicone to prevent any water from contacting or damaging the electronics. Because the lighting element 40 itself is sealed, the connections of the components of the body 18 can be unsealed without risking damage to the lighting components.

The lighting element 40 may be powered by any appropriate means, such as by DC current via a 12 VDC battery. Alternatively, the lighting element 40 may be powered by a DC power converter or power supply from a standard 120 VAC power source. The power may be actuated by any appropriate means, such as a button or switch. For example, the grab handle assembly 10 may include a push button actuator 42 located on a side of the mounting base 16. Alternatively, a switch may be located on a wall or surface near the mounted grab handle assembly 10.

It will be appreciated that instead of the push button actuator 42, the grab handle assembly 10 may include any input to actuate the lighting element 40. For example, the grab handle assembly 10 may include a controller 44 configured to receive an input and control the lighting element 40. The input device 42 may be any appropriate input, including a push button, remotely located push button, remote control, or sensor. In an embodiment, the input 42 may be a proximity sensor configured to sense the presence of a person or object close to the handle assembly 10 and turn the light on for a predetermined length of time when an object or person is detected. The input 42 and controller 44 may also be used to control other aspects of the light, as described in further detail below.

The controller 44 may be positioned in an appropriate location, such as within the body 18 inside a mounting base 14, as shown in FIG. 5. The controller 44 may include electronics and other environmentally sensitive components. To shield these components from potential environmental hazards, the controller 44 may be potted, or surrounded in a protective casing 52, such as a silicon casing. The casing may shield the controller 44 from any water or potentially hazardous environmental conditions that may enter the body 18. By specifically sealing protecting the controller 44 and lighting element 40 from hazardous conditions, it alleviates the need to hermetically seal the grab handle assembly 10 as a whole.

The lighting element 40 may include other lighting capabilities, such as color adjustment. For example, the lighting element 40 may include red/green/blue (RGB) LED lights and be adjustable between a plurality of colors. The controller 44 may include an output to the lighting element configured to vary the color of the light. The controller 44 may receive an input from a color selection input device, connected to or positioned remotely from the grab handle assembly 10. Alternatively, the RGB aspects of the light may be controlled by an input device directly wired or connected to the lighting element.

In an embodiment, the grab handle assembly 10 may include additional lighting features. For example, the grab handle assembly 10 may include a puddle light. The grab handle assembly 10 may be mounted vertically, with one mounting base 14 positioned vertically above the other mounting base 14. The lower mounting base 14 may include a puddle lighting element (not shown) positioned to direct light downward toward the ground adjacent to the mounting surface. The puddle lighting element may be housed within body 18 and arranged to direct light through a second window or through a translucent portion of the body. The puddle lighting element may be connected to and controlled by the controller 44 to allow it to be turned on in response to a sensor, switch, button, or other input received by the controller 44.

In use, the grab handle assembly 10 may be mounted to a wall or surface on a boat or RV near a stairwell or along an outer surface of a boat. The lighting element 40 within the housing 12 may be actuated by a button 42 on the housing or by a switch or appropriate sensor. The lighting element 40 will project light through the window 34 toward the mounting surface to illuminate the mounting surface.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

Having thus described the invention, we claim:

1. An illuminated grab handle assembly comprising:
a housing configured to connect to a mounting surface, the housing comprising:
a body having a first mounting base, a second base, and a crossbar extending between the first mounting base and the second mounting base, the body comprising a generally hollow shape having an open top portion;
a cavity formed in the body and extending for a length between the first mounting base and the second mounting base; and
a top cover connected to a top portion of the body to cover the open top portion;
a window positioned in a surface of the body corresponding to at least a portion of the cavity, the window comprising a translucent surface configured to allow light to pass from within the body to the mounting surface; and
a lighting element disposed within the cavity, the lighting element oriented and positioned to direct light out of the window and toward the mounting surface.

2. The illuminated grab handle assembly of claim 1, wherein the window comprises the only translucent surface on the grab handle housing.

3. The illuminated grab handle assembly of claim 1, wherein the lighting element is hermetically sealed.

4. The illuminated grab handle assembly of claim 1, wherein the crossbar includes a curved shape between the first mounting base and the second mounting base.

5. The illuminated grab handle assembly of claim 4, wherein the lighting element includes a flexible printed circuit board to allow the lighting element to adhere to the curved shape of the crossbar.

6. The illuminated grab handle assembly of claim 1, wherein the lighting element comprises an LED linear light component.

7. The illuminated grab handle assembly of claim 1, wherein the lighting element includes red/green/blue lighting capabilities.

8. The illuminated grab handle assembly of claim 1, further comprising a controller, wherein the controller is configured to control one or more functions of the lighting element.

9. The illuminated grab handle assembly of claim 8 further comprising an input device connected to the controller, wherein the input device is configured to actuate the lighting element.

10. The illuminated grab handle assembly of claim 9 wherein the input device comprises a sensor configured to sense the presence of an object within a preset proximity of the grab handle assembly and actuate the lighting element for a predetermined period of time.

11. The illuminated grab handle assembly of claim 8, wherein the controller is hermetically sealed and positioned within the body.

12. The illuminated grab handle assembly of claim 8, wherein the lighting element includes red/green/blue capabilities and the controller is configured to select the color of the lighting element.

13. The grab handle assembly of claim 1, wherein the body is formed of a translucent or partially translucent material.

14. The grab handle assembly of claim 1 further comprising a second lighting element positioned within the body near an end of the grab handle assembly.

15. The grab handle assembly of claim 14, wherein the second lighting element is configured to direct light toward the ground adjacent to the mounting surface.
